(19) United States
(12) Patent Application Publication
(10) Pub. No.: US 2025/0301035 A1
(43) Pub. Date: Sep. 25, 2025

(54) INFORMATION PROCESSING APPARATUS, INFORMATION PROCESSING METHOD, AND SYSTEM

(71) Applicant: Kota DOHMAE, Kanagawa (JP)

(72) Inventor: Kota DOHMAE, Kanagawa (JP)

(21) Appl. No.: 19/082,171

(22) Filed: Mar. 18, 2025

(30) Foreign Application Priority Data
Mar. 19, 2024 (JP) 2024-043354
Nov. 27, 2024 (JP) 2024-206024

(51) Int. Cl. H04L 67/02; H04L 67/51

(52) U.S. Cl. CPC H04L 67/02; H04L 67/51

(57) ABSTRACT

An information processing apparatus including circuitry to identify a user who operates a communication terminal communicable with the information processing apparatus via a network, the communication terminal being installed with a terminal application, identify an organization to which the user belongs, acquire attribute information on an attribute of the organization, select one or more applications to be recommended to the user from among a plurality of applications available to the user based on the attribute information, transmit web content data described in hypertext markup language (HTML) to the communication terminal in response to receiving a first hypertext transfer protocol (HTTP) request transmitted from the communication terminal, the web content data including a first JAVASCRIPT or link information for referring to a second JAVASCRIPT.

### CROSS-REFERENCE TO RELATED APPLICATIONS

This patent application is based on and claims priority pursuant to 35 U.S.C. § 119 (a) to Japanese Patent Application Nos. 2024-043354, filed on Mar. 19, 2024 and 2024-206024, filed on Nov. 27, 2024, in the Japan Patent Office, the entire disclosure of which is hereby incorporated by reference herein.

### BACKGROUND

### Technical Field

The present disclosure relates to an information processing apparatus, an information processing method, and a system.

### Related Art

A technique for recommending an application to a user has been proposed. For example, the recommendation system classifies the tendency of the frequency of use of an application by a user into clusters and recommends an application to a target user based on the degree of usefulness of the application in the clusters and a recommended condition.

### SUMMARY

The present disclosure described here provides an information processing apparatus including circuitry to identify a user who operates a communication terminal communicable with the information processing apparatus via a network, the communication terminal being installed with a terminal application, identify an organization to which the user belongs, acquire attribute information on an attribute of the organization, select one or more applications to be recommended to the user from among a plurality of applications available to the user based on the attribute information, transmit web content data described in hypertext markup language (HTML) to the communication terminal in response to receiving a first hypertext transfer protocol (HTTP) request transmitted from the communication terminal, the web content data including a first JAVASCRIPT or link information for referring to a second JAVASCRIPT, the first JAVASCRIPT being for acquiring application information on the one or more applications to be recommended from the information processing apparatus, the second JAVASCRIPT being for acquiring the application information from the information processing apparatus, and transmit at least an application name of each of the one or more applications to be recommended to the communication terminal in response to receiving a second HTTP request, the second HTTP request being transmitted from the communication terminal in response to execution of the first JAVASCRIPT or the second JAVASCRIPT by the terminal application, the web content data causing the communication terminal to display the application name on a screen based on the application name transmitted from the information processing apparatus.

In another aspect, an information processing method performed by an information processing apparatus includes identifying a user who operates a communication terminal communicable with the information processing apparatus via a network, the communication terminal being installed with a terminal application, acquiring attribute information on an attribute of the organization, selecting one or more applications to be recommended to the user from among a plurality of applications available to the user based on the attribute information, transmitting web content data described in hypertext markup language (HTML) to the communication terminal in response to receiving a first hypertext transfer protocol (HTTP) request transmitted from the communication terminal, the web content data including a first JAVASCRIPT or link information for referring to a second JAVASCRIPT, the first JAVASCRIPT being for acquiring application information on the one or more applications to be recommended from the information processing apparatus, the second JAVASCRIPT being for acquiring the application information from the information processing apparatus, and transmitting at least an application name of each of the one or more applications to be recommended to the communication terminal in response to receiving a second HTTP request, the HTTP request being transmitted from the communication terminal in response to execution of the first JAVASCRIPT or the second JAVASCRIPT by the terminal application, the web content data causing the communication terminal to display the application name on a screen based on the application name transmitted from the information processing apparatus.

In another aspect, a system includes a communication terminal installed with a terminal application for causing the communication terminal to display web content data and an information processing apparatus to communicate with the communication terminal via a network. The information processing apparatus includes first circuitry to identify a user who operates the communication terminal, identify an organization to which the user belongs, acquire attribute information on an attribute of the organization, select one or more applications to be recommended to the user from among a plurality of applications available to the user based on the attribute information, and transmit the web content data described in HTML to the communication terminal in response to receiving a first HTTP request transmitted from the communication terminal, the web content data including a first JAVASCRIPT or link information for referring to a second JAVASCRIPT, the first JAVASCRIPT being for acquiring application information on the one or more applications to be recommended from the information processing apparatus, the second JAVASCRIPT being for acquiring the application information from the information processing apparatus, and transmit at least an application name of each of the one or more applications to be recommended to the communication terminal in response to receiving a second HTTP request. The communication terminal includes second circuitry to transmit the first HTTP request, transmit the second HTTP request in response to execution of the first JAVASCRIPT or the second JAVASCRIPT by the terminal application, and display the application name on a screen based on the application name transmitted from the information processing apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an information processing system;

FIG. 2 is a block diagram illustrating a hardware configuration of a computer;

FIG. 3 is a block diagram illustrating a functional configuration of an information processing system;

FIG. 4 is a diagram illustrating a data structure of user information;

FIG. 5 is a diagram illustrating a data structure of tenant information;

FIG. 6 is a diagram illustrating a data structure of application information;

FIG. 7 is a sequence diagram illustrating a registration process;

FIG. 8 is a diagram illustrating an application management screen;

FIG. 9 is a diagram illustrating an application registration screen;

FIG. 10 is a sequence diagram illustrating a recommendation process;

FIG. 11 is a diagram illustrating a login screen;

FIG. 12 is a diagram illustrating a portal screen;

FIG. 13 is a diagram illustrating an application addition screen;

FIG. 14 is a diagram illustrating a recommendation screen;

FIG. 15 is a table illustrating a data structure of user information;

FIG. 16 is a table illustrating a data structure of application information;

FIG. 17 is a sequence diagram illustrating a screen display process; and

FIG. 18 is a diagram illustrating a recommendation screen.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described in detail below with reference to the drawings. In the drawings, like reference numerals denote like elements, and redundant descriptions thereof may be omitted.

In one embodiment of the present disclosure, an information processing system that provides a user with an application is described. The application may be, for example, a web application executed on a browser, or a native application installed and executed in a computer. Examples of the application include not only applications for performing tasks such as document generation, form management, and video editing, and communications such as a telephone call, a video call, and a conference, but also other general-purpose applications and games. Examples of the games include an online game and a game installed and executed in a game console. In the present embodiment, a case in which the information processing system provides the web application is described.

In the present embodiment, the information processing system provides the user with the application through an online market. The online market is an information and communication service that receives registration of an application via a communication network and provides the registered application to the user. In the online market, the application that is available free of charge may be provided, or the application that is available with a fee may be provided. In the following description, the online market is referred to as an “application market.” Examples of the application market include GOOGLE play store and APPLE store.

In the present embodiment, the application market provides applications that the user belonging to an organization uses for the tasks of the organization. The organization is a group of multiple members who carry out given tasks. The organization may include, for example, a division within an organization or a complex of organizations. Examples of the organization include a company, an educational institution, a local government, and a union. In the present embodiment, a case in which the organization is a company and the user is an employee of the company is described.

In the present embodiment, the application market has a function to recommend an application to the user. The technique in the related art recommends an application suitable for the user based on, for example, the attribute information on the user or the usage history of the user. In some cases, it is desired to recommend an application to the user belonging to the organization to help the user accomplish the tasks of the organization. Even if the application is selected based on the attribute information or usage history of the individual user, the selected application may not be an application appropriate to accomplish the tasks of the organization. Furthermore, when the user uses the application market for the first time, the usage history of the user may not be acquired. In view of the above, by selecting an application based on the information on the organization, an application to be used for the tasks of the organization can be recommended.

In the present embodiment, an application suitable for the organization to which the user belongs is selected for recommendation to the user. Specifically, the attribute information on the organization to which the user belongs is acquired, and an application is selected to be recommended to the user based on the acquired attribute information. In one aspect, since an application is selected based on the attribute information on the organization to which the user belongs, the selected application can be recommended to the user to accomplish the tasks of the organization.

In the present embodiment, recommending an application is not limited to explicitly indicating to the user that the application is recommended. An example of not explicitly indicating the user that the application is recommended includes displaying recommended applications in a list without explicitly indicating that the applications are recommended. Another example includes displaying only the recommended applications without explicitly indicating that the applications are recommended first, and then displaying applications other than the recommended applications according to an operation by the user.

### Overall Configuration of Information Processing System

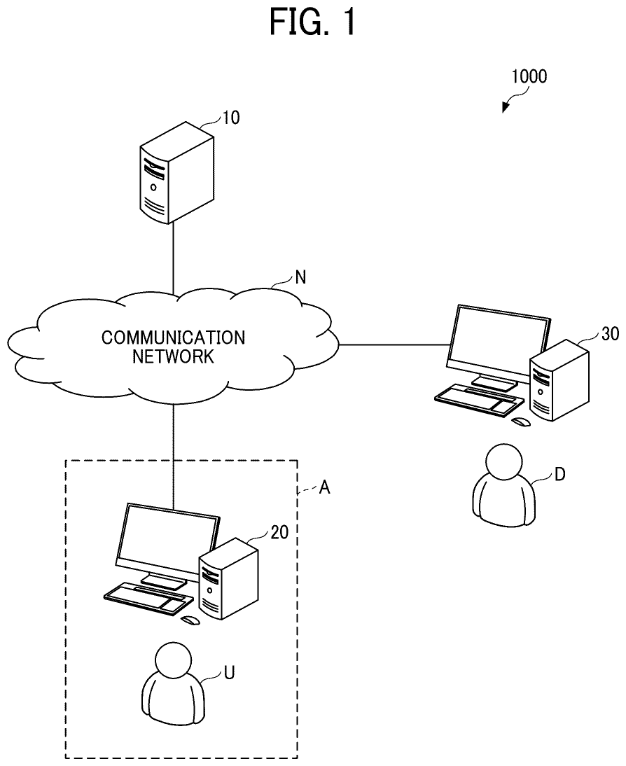

The overall configuration of the information processing system according to the present embodiment is described with reference to FIG. 1. FIG. 1 is a diagram illustrating an overall configuration of an information processing system 1000.

As illustrated in FIG. 1, the information processing system 1000 includes an information processing apparatus 10, a communication terminal 20, and a communication terminal 30. The information processing apparatus 10, the communication terminal 20, and the communication terminal 30 are connected to a communication network N. The communication network N enables the connected apparatuses to communicate with one another.

The communication network N is implemented by, for example, a wired communication network such as the Internet, a local area network (LAN), or a wide area network (WAN). The communication network N may include not only the wired communication network but also a wireless communication network such as a wireless LAN or a short-range wireless communication, or a mobile communication network such as Worldwide Interoperability for Microwave Access (WiMAX), Long Term Evolution (LTE), or the fifth generation (5G).

The information processing apparatus 10 is an example of an information processing apparatus that provides a user U who belongs to an organization A with an application market. The information processing apparatus 10 may be, for example, a computer such as a personal computer, a workstation, or a server.

In the present embodiment, the application market is operated as a multi-tenant system. In the multi-tenant system, multiple tenants (for example, service users such as companies or clients) share resources, and an account can be created for each tenant. In the application market according to the multi-tenant system, a tenant may be created for each organization, such as the organization A, to which each user, such as the user U, belongs.

In the application market, connection destination information indicating a connection destination of a tenant may be set for each tenant. The connection destination information may be, for example, a uniform resource locator (URL) or a domain name. As an example, in the application market, identification information, such as tenant identification (ID), for identifying a tenant may be embedded in the URL for connecting to a login screen. The information processing apparatus 10 identifies the tenant (i.e., the organization A) to which the user U belongs, based on the connection destination information used for connecting to the login screen.

In the application market, input of identification information (tenant ID) for identifying a tenant may be received on the login screen. On the login screen, input of a tenant ID may be received as part of the authentication information. When the user U logs in to the application market, the information processing apparatus 10 identifies the tenant (i.e., the organization A) to which the user U belongs, based on the authentication information input by the user U.

The communication terminal 20 is an example of an information processing terminal operated by the user U. The user U belongs to a specific organization A and operates the communication terminal 20 to carry out the tasks of the organization A. The communication terminal 20 may be provided in a facility such as an office where the tasks of the organization A are carried out, or may be carried by the user U when the user U carries out the tasks of the organization A. The communication terminal 20 may be, for example, a computer such as a personal computer, a smartphone, or a tablet terminal.

The communication terminal 30 is an example of an information processing terminal operated by a developer D. The developer D is a user who develops applications and registers the completed applications in the application market. The developer D does not necessarily belong to the specific organization A. The developer D may be, for example, an administrator of the information processing system 1000. The communication terminal 30 may be, for example, a computer such as a personal computer, a smartphone, or a tablet terminal.

Each of the communication terminals 20 and 30 is not limited to an information processing apparatus as long as the information processing apparatus has a communication function. Each of the communication terminals 20 and 30 may be, for example, an image forming apparatus such as a printer, a facsimile machine, a multifunction peripheral/product/printer, or a scanner, a projector, an interactive white board (IWB; an electronic white board having a blackboard function capable of mutual communication), an output device such as a digital signage, a head-up display (HUD) device, an industrial machine, an imaging device, a sound collecting device, a medical device, a network home appliance, an automobile (connected car), a laptop personal computer (PC), a mobile phone, a smartphone, a tablet terminal, a game console, a personal digital assistant (PDA), a digital camera, a wearable PC, or a desktop PC.

The overall configuration of the information processing system 1000 illustrated in FIG. 1 is given by way of example, and various system configurations may be employed depending on usage and purposes. For example, in the information processing system 1000, a plurality of one or more of the information processing apparatus 10, the communication terminal 20, and the communication terminal 30 may be included. For example, the information processing apparatus 10 may be implemented by multiple computers or may be implemented as a cloud computing service. The divisions of the apparatuses such as the information processing apparatus 10, the communication terminal 20, and the communication terminal 30 illustrated in FIG. 1 are given by way of example.

### Hardware Configuration of Information Processing System

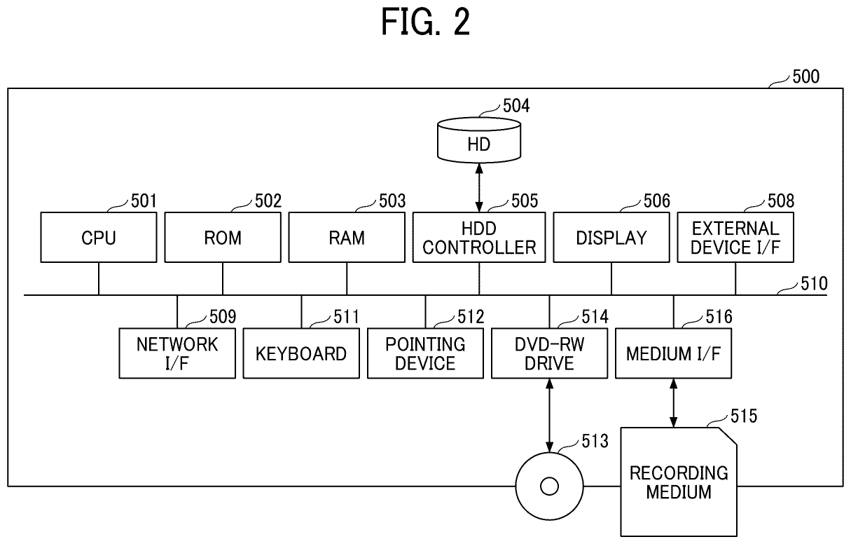

The hardware configuration of the information processing system 1000 is described with reference to FIG. 2.

### Computer

Each of the information processing apparatus 10, the communication terminal 20, and the communication terminal 30 may be implemented by a computer. FIG. 2 is a block diagram illustrating a hardware configuration of a computer 500.

As illustrated in FIG. 2, the computer 500 includes a central processing unit (CPU) 501, a read-only memory (ROM) 502, a random-access memory (RAM) 503, a hard disk (HD) 504, a hard disk drive (HDD) controller 505, a display 506, an external device interface (I/F) 508, a network interface (I/F) 509, a bus line 510, a keyboard 511, a pointing device 512, a digital versatile disc-rewritable (DVD-RW) drive 514, and a medium interface (I/F) 516.

The CPU 501 controls the entire operation of the computer 500. The ROM 502 stores a program such as an initial program loader (IPL) used for booting the CPU 501. The RAM 503 is used as a work area for the CPU 501. The HD 504 stores various data such as a program. The HDD controller 505 controls the reading and writing of data from and to the HD 504 under the control of the CPU 501.

The display 506 displays various information such as a cursor, a menu, a window, characters, and images. The external device I/F 508, which may be implemented by an interface circuit, is an interface that controls communication of data with various external devices. Examples of the external devices in this case include, but are not limited to, a universal serial bus (USB) memory and a printer. The network I/F 509, which may be implemented by an interface circuit, is an interface that controls communication of data through the communication network N. The bus line 510 is, for example, an address bus or a data bus, which electrically connects the components or elements such as the CPU 501 to each other.

The keyboard 511 serves as an input device provided with a plurality of keys used for, for example, inputting characters, numerical values, and various instructions. The pointing device 512 serves as an input device used for, for example, selecting or executing various instructions, selecting an object to be processed, and moving a cursor being displayed. The DVD-RW drive 514 controls the reading and writing of various data from and to a DVD-RW 513, which serves as a removable recording medium according to the present embodiment. The removable recording medium is not limited to a DVD-RW and may be, for example, a digital versatile disc-recordable (DVD-R). The medium I/F 516 controls the reading and writing (storing) of data from and to a recording medium 515 such as a flash memory.

### Functional Configuration of Information Processing System

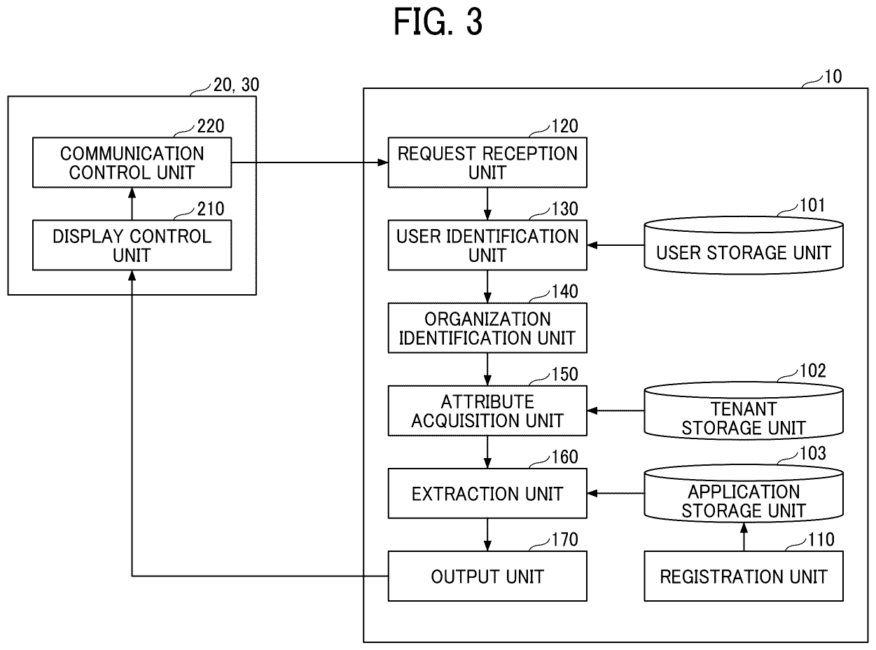

The functional configuration of the information processing system 1000 is described with reference to FIG. 3. FIG. 3 is a block diagram illustrating a functional configuration of the information processing system 1000.

### Information Processing Apparatus

As illustrated in FIG. 3, the information processing apparatus 10 includes a user storage unit 101, a tenant storage unit 102, an application storage unit 103, a registration unit 110, a request reception unit 120, a user identification unit 130, an organization identification unit 140, an attribute acquisition unit 150, an extraction unit 160, and an output unit 170.

The user storage unit 101, the tenant storage unit 102, and the application storage unit 103 are implemented by, for example, the HD 504 illustrated in FIG. 2. The reading and writing of data from and to the HD 504 are performed, for example, under control of the HDD controller 505.

The registration unit 110, the request reception unit 120, the user identification unit 130, the organization identification unit 140, the attribute acquisition unit 150, the extraction unit 160, and the output unit 170 are implemented by, for example, processing executed by the CPU 501 that operates in cooperation with the network I/F 509 according to a program loaded from the ROM 502 to the RAM 503 illustrated in FIG. 2.

In the user storage unit 101, user information on the user U is stored for each tenant. The user information includes identification information (user ID) for identifying the user U and authentication information for authenticating the user U.

### User Information

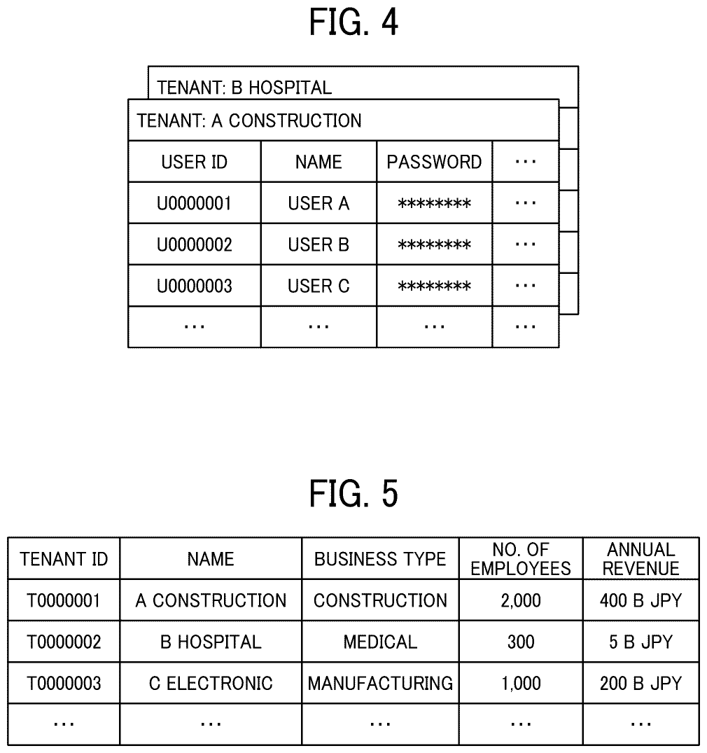

FIG. 4 is a table illustrating the data structure of the user information according to the present embodiment. As illustrated in FIG. 4, the user information includes, for example, a user ID, a name, and a password as data items. The user ID and the password are examples of authentication information.

In the tenant storage unit 102, tenant information on the organization A is stored. The tenant information includes, as data items, the identification information (tenant ID) for identifying the organization A and attribute information indicating attributes of the organization A. The attribute information on the organization A may include information indicating the type of business and information indicating the scale.

Attributes of an organization represent the nature and characteristics of the organization. The type of business is given by way of example as the nature and characteristics of an organization. The type of business indicates a type of business that a company or individual operates. Examples of the type of business are construction, manufacturing, fishing, agriculture, and finance. The type of business may be based on, for example, the “Japan Standard Industrial Classification” published by the Ministry of Internal Affairs and Communications, or may be based on another unique classification. In the case of a school such as a university, the attribute of the organization may be a major such as a department or a faculty.

### Tenant Information

FIG. 5 is a table illustrating a data structure of the tenant information. As illustrated in FIG. 5, the tenant information includes, for example, a tenant ID, a name, a type of business, the number of employees, and annual revenue as data items. The name, the type of business, the number of employees, and the annual revenue are examples of the attribute information on the organization A. The type of business is an example of information indicating a type of business. The number of employees and annual revenue are examples of information indicating the scale. The information indicating the type of business may be automatically set by inferring the type of business from a character string included in the name when the tenant information is stored.

In the application storage unit 103, applications available in the application market and application information on the applications are stored. The application information includes identification information (application ID) for identifying an application, classification information indicating a classification of the application, and a recommended condition indicating conditions under which the application is recommended to be used. The recommended condition may include conditions relating to the attribute information included in the tenant information. The application information is an example of setting information for associating an application with a recommended condition.

### Application Information

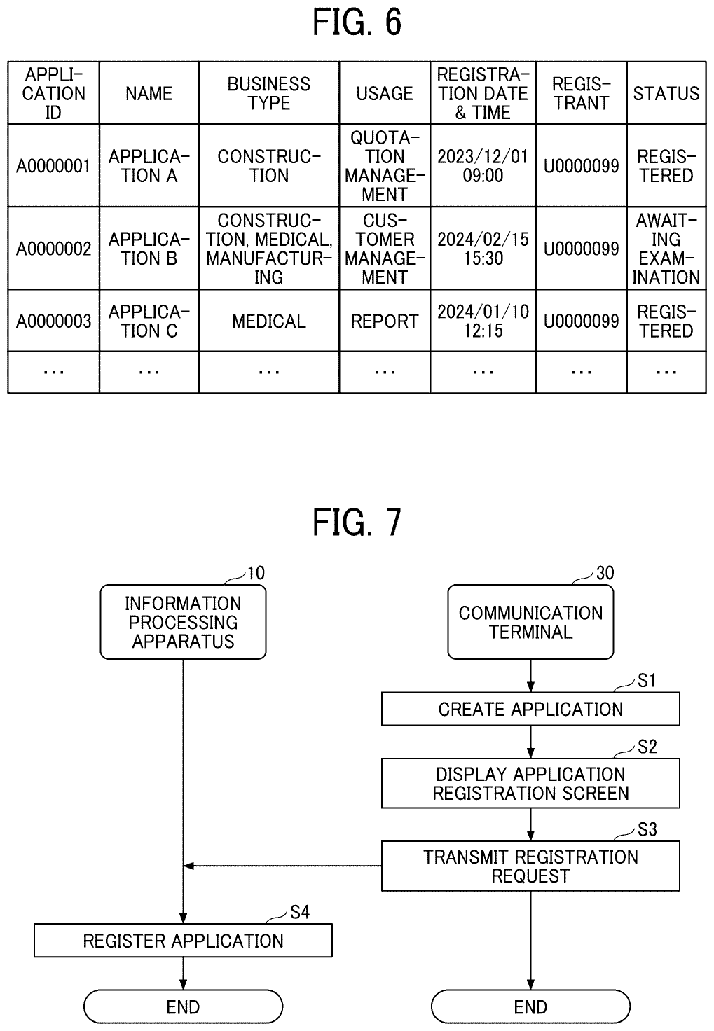

FIG. 6 is a table illustrating a data structure of the application information. As illustrated in FIG. 6, the application information includes, for example, an application ID, a name, a type of business, a usage, a registration date and time, a registrant, and a status as data items. The type of business is an example of a recommended condition, and is a condition relating to the type of business of the tenant information. The usage is an example of the classification information.

The registration date and time is the date and time when an application is registered in the application market. When an application stored in the application storage unit 103 is updated, the registration date and time may be the date and time when the application is updated to the latest application. The registrant is identification information for identifying the developer D who registers the application. The status is information indicating the registration status of the application. Examples of the registration status are “registered,” “awaiting examination,” and “deleted.”

In response to a request from the communication terminal 30, the registration unit 110 stores an application and application information on the application in the application storage unit 103. The application and application information are input to the communication terminal 30 by the developer D.

The request reception unit 120 receives a request from the communication terminal 20 or the communication terminal 30. The request reception unit 120 may receive a request for authenticating the user U and a request for acquiring various screens from the communication terminal 20. The request reception unit 120 may receive a request for registering an application and a request for acquiring various screens from the communication terminal 30.

The user identification unit 130 identifies the user U who operates the communication terminal 20. The user identification unit 130 may identify the user U based on the authentication information input to the communication terminal 20 by the user U. The authentication information may be, for example, a user ID and a password. The authentication information may include a tenant ID. The user identification unit 130 collates the authentication information input by the user U with the authentication information included in the user information read from the user storage unit 101 to authenticate the user U. The user identification unit 130 identifies the user U who is successfully authenticated as the user U who operates the communication terminal 20.

The user identification unit 130 instructs the communication terminal 20 to store information (for example, a user ID) indicating the user U who has been identified. As an example, the user identification unit 130 may instruct the communication terminal 20 to store the user ID in a session storage of a browser of the communication terminal 20. Alternatively, the user identification unit 130 may instruct the communication terminal 20 to store the user ID in a storage device such as the RAM 503 or the HD 504 of the communication terminal 20.

The organization identification unit 140 identifies the organization A to which the user U identified by the user identification unit 130 belongs. Alternatively, the organization identification unit 140 may identify the organization A based on the connection destination information of the communication terminal 20. Still alternatively, the organization identification unit 140 may identify the organization A based on the authentication information input by the user U to the communication terminal 20.

The organization identification unit 140 instructs the communication terminal 20 to store information (for example, a tenant ID) indicating the organization A that has been identified. As an example, the organization identification unit 140 may instruct the communication terminal 20 to store the tenant ID in the session storage of the browser of the communication terminal 20. Alternatively, the organization identification unit 140 may instruct the communication terminal 20 to store the tenant ID in a storage device such as the RAM 503 or the HD 504 of the communication terminal 20.

The attribute acquisition unit 150 acquires attribute information on the organization A identified by the organization identification unit 140. The attribute acquisition unit 150 may read out the attribute information on the organization A identified by the organization identification unit 140 from the tenant storage unit 102.

The extraction unit 160 extracts an application recommended to the user U based on the attribute information on the organization A acquired by the attribute acquisition unit 150. For example, the extraction unit 160 extracts one or more applications recommended to the user U from among the applications available to the user U, based on the attribute information on the organization A. Specifically, the extraction unit 160 extracts, from among the pieces of application information read from the application storage unit 103, one or more pieces of application information for which the attribute information on the organization A satisfies the recommended condition.

The output unit 170 outputs control information for causing the communication terminal 20 to display information on the one or more applications recommended to the user U, based on the application information extracted by the extraction unit 160. The output unit 170 may output the control information and transmit the control information to the communication terminal 20.

The control information is, for example, screen data for displaying a screen on the display 506 of the communication terminal 20. The screen data is, for example, electronic data described in a hypertext markup language (HTML) or the like, and may include a program described in a script language such as JAVASCRIPT. In the screen data, a list of applications recommended to the user U may be embedded.

The control information may cause the communication terminal 20 to display information on the applications based on a display rule determined in advance. The display rule may be a rule indicating the number and order of applications to be displayed by the communication terminal 20. The display rule may include a rule relating to the registration date and time of the application. The display rule may be, for example, a rule that ten applications are displayed in order of most recent registration date and time. As another example, the display rule may be a rule that ten applications most distributed in the application market are displayed in descending order.

### Communication Terminal

As illustrated in FIG. 3, each of the communication terminals 20 and 30 includes a display control unit 210 and a communication control unit 220.

The display control unit 210 and the communication control unit 220 are implemented by, for example, processing executed by the CPU 501 that operates in cooperation with the network I/F 509 according to a program loaded from the ROM 502 to the RAM 503 illustrated in FIG. 2.

The display control unit 210 controls the display of a screen provided by the application market on the display 506 based on the screen data received from the information processing apparatus 10. The display control unit 210 may be implemented by an application having a browser function. The application having a browser function may be a web browser installed in advance in the communication terminal 20, or may be an application for displaying web contents using the Web View function.

The display control unit 210 of the communication terminal 20 may display, for example, a login screen, a portal screen, an application addition screen, and a recommendation screen on the display 506. Alternatively, the login screen, the portal screen, the application addition screen, and the recommendation screen may be displayed by, for example, an application having a browser function installed in advance in the communication terminal 20.

The display control unit 210 of the communication terminal 30 may display, for example, an application management screen and an application registration screen on the display 506. Alternatively, the application management screen and the application registration screen may be displayed by, for example, an application having a browser function installed in advance in the communication terminal 30.

The communication control unit 220 controls communication with the information processing apparatus 10. The communication control unit 220 of the communication terminal 20 may transmit the authentication information to the information processing apparatus 10. The communication control unit 220 of the communication terminal 30 may transmit the application information to the information processing apparatus 10. The communication control unit 220 may receive the screen data from the information processing apparatus 10.

### Processing Executed by Information Processing System

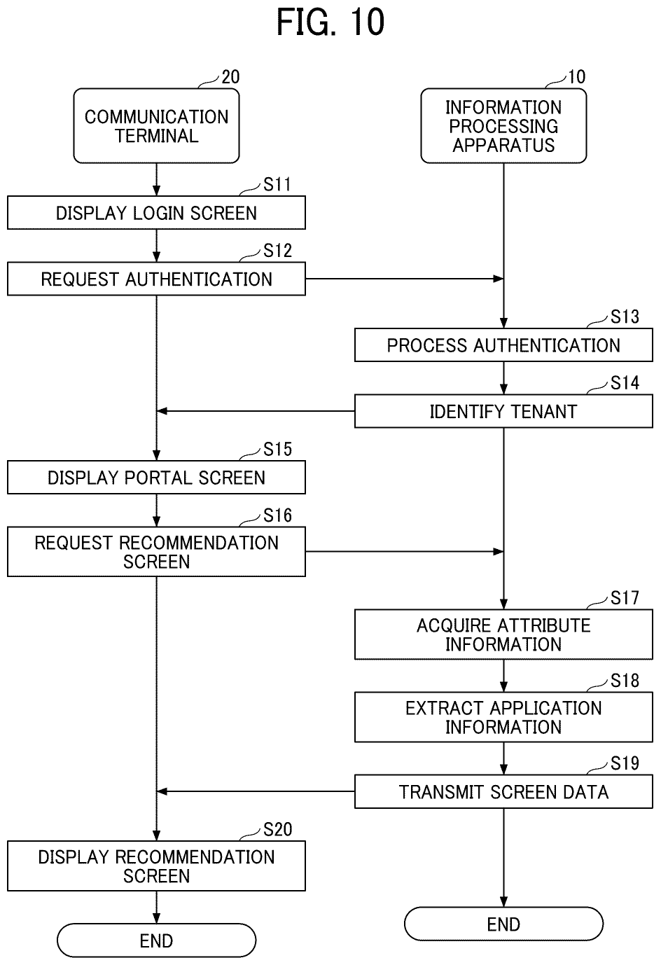

The information processing method executed by the information processing system 1000 is described below with reference to FIGS. 7 to 14. The information processing method includes a registration process (see FIG. 7) and a recommendation process (see FIG. 10).

### Registration Process

FIG. 7 is a sequence diagram illustrating a registration process. The registration process is a process to register an application in the application market.

In step S1, the information processing apparatus 10 creates an application to be registered in the application market according to an instruction from the developer D. The developer D may instruct to create the application by operating, for example, a development screen provided by the information processing apparatus 10. As another example, the developer D may instruct to create the application using a development tool installed in advance in the communication terminal 30.

In step S2, the communication terminal 30 opens the application management screen according to an instruction from the developer D. The developer D may operate to log in to the application market prior to the operation of opening the application management screen. The communication control unit 220 of the communication terminal 30 transmits a request for acquiring the application management screen to the information processing apparatus 10 in response to an operation by the developer D.

The request reception unit 120 of the information processing apparatus 10 receives, from the communication terminal 30, the request for acquiring the application management screen. The request reception unit 120 notifies the output unit 170 of the request for acquiring the application management screen. In response to the request for acquiring the application management screen, the output unit 170 transmits screen data for displaying the application management screen to the communication terminal 30. In the screen data, the application information stored in the application storage unit 103 is embedded. More specifically, the output unit 170 obtains the application information from the application storage unit 103, and generates the screen data that includes the application information. The display control unit 210 of the communication terminal 30 displays the application management screen on the display 506 based on the screen data received from the information processing apparatus 10.

### Application Management Screen

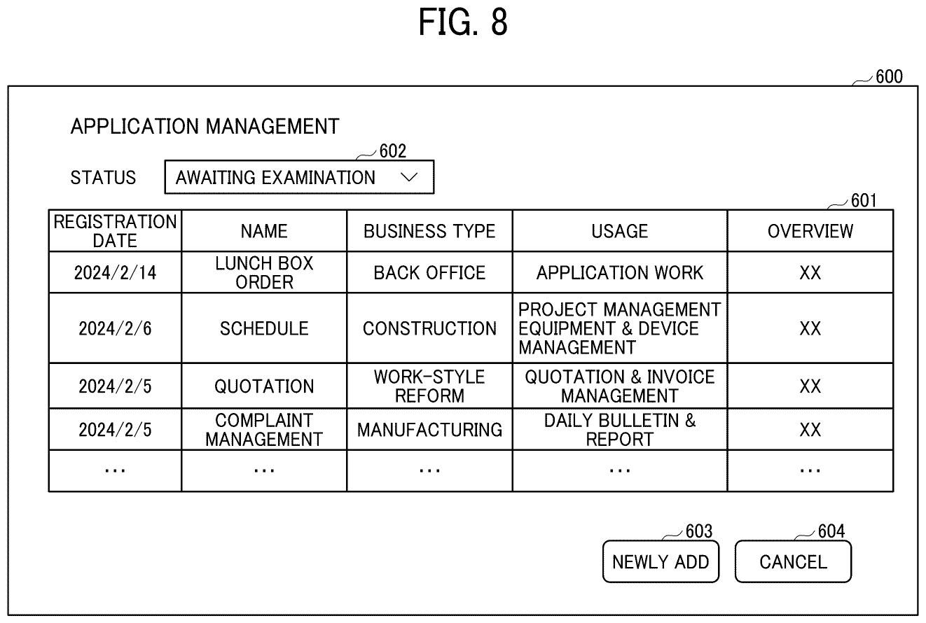

FIG. 8 is a diagram illustrating an application management screen 600. As illustrated in FIG. 8, the application management screen 600 includes a list display area 601, a status selection field 602, an add button 603, and a cancel button 604.

In the list display area 601, a list of applications registered in the application market is displayed. In the list display area 601, a registration date, a name, a type of business, a usage, and an overview are also displayed for each of the applications registered in the application market. The registration date, the name, the type of business, the usage, and the overview correspond to the registration date and time, the name, the type of business, the usage, and the overview included in the application information, respectively.

The application information of the applications may be updated by an operation in the list display area 601. For example, when the developer D performs an operation (for example, a double-click) of selecting an application in the list display area 601, the screen may be transitioned to the application registration screen for updating the application.

The status selection field 602 is a screen component used for selecting a status of the application to be displayed in the list display area 601. When a status is selected in the status selection field 602, only the application having the selected status is displayed in the list display area 601. In FIG. 8, a case in which the status selection field 602 is configured by a combo box in which only one option can be selected is illustrated. However, the status selection field 602 may be configured by a screen component in which multiple options can be selected.

The add button 603 is a button used for adding an application. When the developer D presses the add button 603, the application registration screen for newly registering an application is displayed on the display 506.

The cancel button 604 is a button used for closing the application management screen 600. When the developer D presses the cancel button 604, the application management screen 600 is closed.

### Application Registration Screen

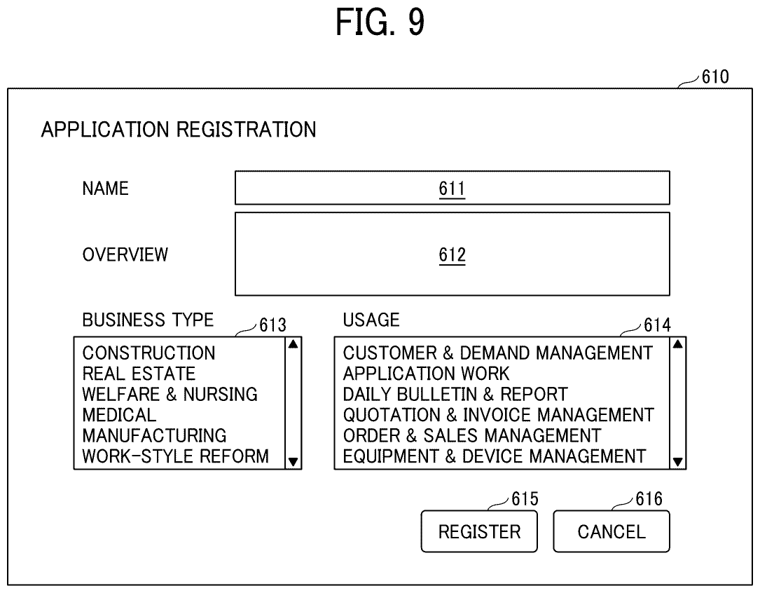

FIG. 9 is a diagram illustrating an application registration screen 610. As illustrated in FIG. 9, the application registration screen 610 includes a name input field 611, an overview input field 612, a type of business selection field 613, a usage selection field 614, a registration button 615, and a cancel button 616.

In the name input field 611, a name of an application is input. In the overview input field 612, an overview of the application is input.

In the type of business selection field 613, a selection of a type of business for which the application to be registered is recommended for use is received. In the type of business selection field 613, options of types of business determined in advance are displayed. In the type of business selection field 613, a selection of at least one option from the displayed options is received. In the type of business selection field 613, a selection of multiple options from the displayed options may be received. In FIG. 9, a case in which the type of business selection field 613 is configured by a list box in which multiple options can be selected is illustrated. However, the type of business selection field 613 may be configured by any screen component that allows multiple options to be selected.

In the usage selection field 614, a selection of usage of the application is received. In the usage selection field 614, options of usage determined in advance are displayed. In the usage selection field 614, a selection of at least one option from the displayed options is received. In the usage selection field 614, a selection of multiple options from the displayed options may be received. In FIG. 9, a case in which the usage selection field 614 is configured by a list box in which multiple options can be selected is illustrated. However, the usage selection field 614 may be configured by any screen component that allows multiple options to be selected.

When an application is newly registered, an initial value is displayed in each of the name input field 611, the overview input field 612, the type of business selection field 613, and the usage selection field 614. When an existing application is updated, the name, the overview, the type of business, and the usage of the existing application are displayed in the name input field 611, the overview input field 612, the type of business selection field 613, and the usage selection field 614, respectively.

The registration button 615 is a button used for requesting registration of an application. When the developer D presses the registration button 615, a request for registering the application is received. The registration button 615 may be controlled so as to be enabled to be pressed when the required input items are input.

The cancel button 616 is a button used for closing the application registration screen 610. When the developer D presses the cancel button 616, the application registration screen 610 is closed, and the screen returns to the application management screen 600. At this time, the information input on the application registration screen 610 is discarded.

Returning to FIG. 7, the description continues. In step S3, the communication control unit 220 of the communication terminal 30 transmits a request for registering the application to the information processing apparatus 10 in response to an operation by the developer D. The request for registering the application includes the application information input on the application registration screen 610.

In step S4, the request reception unit 120 of the information processing apparatus 10 receives the request for registering the application from the communication terminal 30. The request reception unit 120 notifies the registration unit 110 of the request for registering the application. The registration unit 110 acquires the application information from the request for registering the application. The registration unit 110 stores the acquired application information in the application storage unit 103. At this time, the registration unit 110 sets the current date and time as the registration date and time, and sets the user ID of the developer D as the registrant.

When an application is newly added, the registration unit 110 newly issues an application ID for the newly added application and stores the application information including the application ID newly issued in the application storage unit 103. When the existing application is updated, the registration unit 110 updates the application information for the existing application stored in the application storage unit 103 with the application information acquired from the request for registering the application.

### Recommendation Process

FIG. 10 is a sequence diagram illustrating a recommendation process. The recommendation process is a process of displaying an application registered in the application market for recommendation to the user U.

In step S11, the communication terminal 20 displays a login screen. The user U operates the communication terminal 20 to connect to the application market. The operation of connecting to the application market may be, for example, an operation of inputting connection destination information to a login screen in a web browser installed in advance in the communication terminal 20. The communication control unit 220 of the communication terminal 20 transmits a request for acquiring the login screen to the information processing apparatus 10 in response to the operation by the user U. The request for acquiring the login screen includes the connection destination information input to the web browser.

The request reception unit 120 of the information processing apparatus 10 receives, from the communication terminal 20, the request for acquiring the login screen. The request reception unit 120 notifies the output unit 170 of the request for acquiring the login screen. The output unit 170 transmits screen data for displaying the login screen to the communication terminal 20. The display control unit 210 of the communication terminal 20 displays the login screen on the display 506 based on the screen data received from the information processing apparatus 10.

### Login Screen

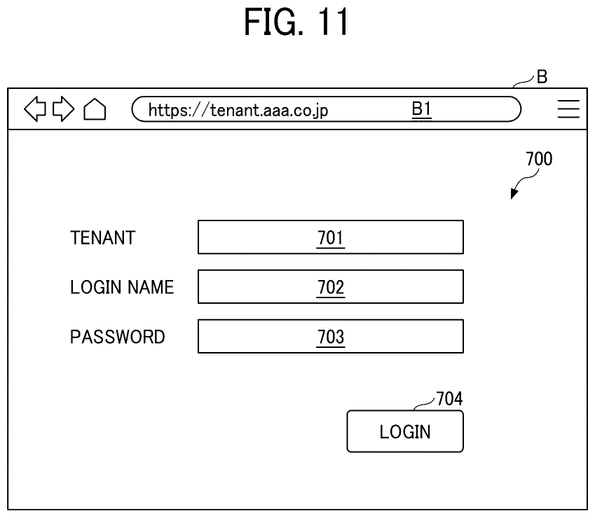

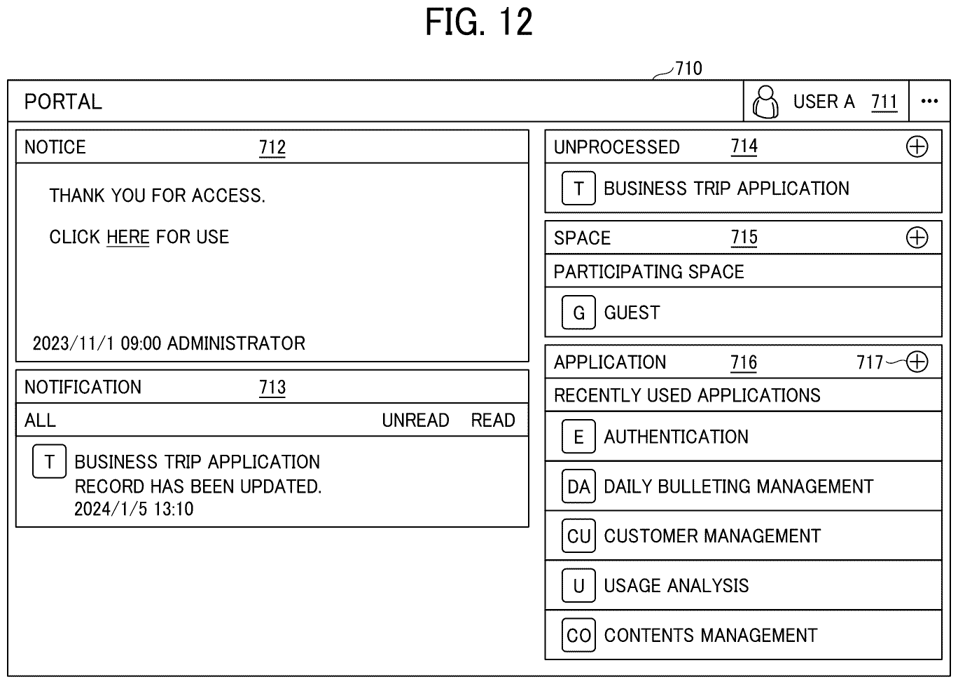

FIG. 11 is a diagram illustrating a login screen 700. As illustrated in FIG. 11, the login screen 700 is displayed by a browser B. The browser B includes an address bar B1 used for inputting a URL, which is an example of the connection destination information.

The login screen 700 includes a tenant input field 701, a login name input field 702, a password input field 703, and a login button 704. In the tenant input field 701, a tenant ID is input. In the login name input field 702, a user ID is input. In the password input field 703, a password is input. In FIG. 11, a case in which a tenant ID is input as part of the authentication information is illustrated. In the case where the tenant ID is embedded in the URL input to the address bar B1, the tenant input field 701 may be omitted.

The login button 704 is a button used for requesting authentication of the user U. When the user U presses the login button 704, the request for authenticating the user U is received.

Returning to FIG. 10, the description continues. In step S12, the communication control unit 220 of the communication terminal 20 transmits a request for authenticating the user U to the information processing apparatus 10 in response to the operation by the user U. The request for authenticating the user U includes the authentication information input on the login screen 700.

In step S13, the request reception unit 120 of the information processing apparatus 10 receives the request for authenticating the user U from the communication terminal 20. The request reception unit 120 notifies the user identification unit 130 of the request for authenticating the user U. The user identification unit 130 reads out the user information from the user storage unit 101. The user identification unit 130 authenticates the user U based on the authentication information included in the user information and the authentication information included in the request for authenticating the user U. In the following description, it is assumed that the user U is successfully authenticated. When the user U is successfully authenticated, the user identification unit 130 identifies the user U who operates the communication terminal 20 based on the user ID included in the request for authenticating the user U.

In step S14, the organization identification unit 140 of the information processing apparatus 10 identifies the organization A to which the user U identified by the user identification unit 130 belongs. The organization identification unit 140 may acquire the tenant ID included in the connection destination information received in step S11. Alternatively, the organization identification unit 140 may acquire the tenant ID included in the request for authenticating the user U received in step S13. The organization identification unit 140 identifies the organization A to which the user U belongs based on the acquired tenant ID.

The output unit 170 transmits the authentication result of the user U to the communication terminal 20. The authentication result includes the user ID identified in step S13 and the tenant ID identified in step S14.

In step S15, the communication control unit 220 of the communication terminal 20 receives the authentication result of the user U from the information processing apparatus 10. In the case where the authentication result indicates that the authentication is successful, the communication control unit 220 stores the user ID and the tenant ID included in the authentication result in the session storage of the browser B.

The communication control unit 220 of the communication terminal 20 transmits a request for acquiring the portal screen to the information processing apparatus 10. The request reception unit 120 of the information processing apparatus 10 receives, from the communication terminal 20, the request for acquiring the portal screen. The request reception unit 120 notifies the output unit 170 of the request for acquiring the portal screen. The output unit 170 transmits screen data for displaying the portal screen to the communication terminal 20. The display control unit 210 of the communication terminal 20 displays the portal screen on the display 506 based on the screen data received from the information processing apparatus 10.

### Portal Screen

FIG. 12 is a diagram illustrating a portal screen 710. As illustrated in FIG. 12, the portal screen 710 includes a user display field 711, a notice display area 712, a notification display area 713, an unprocessed task display area 714, a space display area 715, and an application display area 716.

In the user display field 711, information (e.g., a name) on the user U who is successfully authenticated in step S13 is displayed. In the notice display area 712, notice information for the user U is displayed. In the notification display area 713, notifications regarding the tasks of the user U are displayed. In the unprocessed task display area 714, unprocessed tasks of the user U are displayed. In the space display area 715, information on the space in which the user U participates is displayed.

The tasks of the user U are tasks that are being processed by the applications used by the user U. The tasks may include tasks relating to the operations of the organization A. The space is a virtual space in which information can be shared with other users.

In the application display area 716, information on the applications used by the user U is displayed. The application display area 716 includes an add button 717. The add button 717 is a button used for adding an application. When the user U presses the add button 717, the application addition screen is displayed on the display 506.

### Application Addition Screen

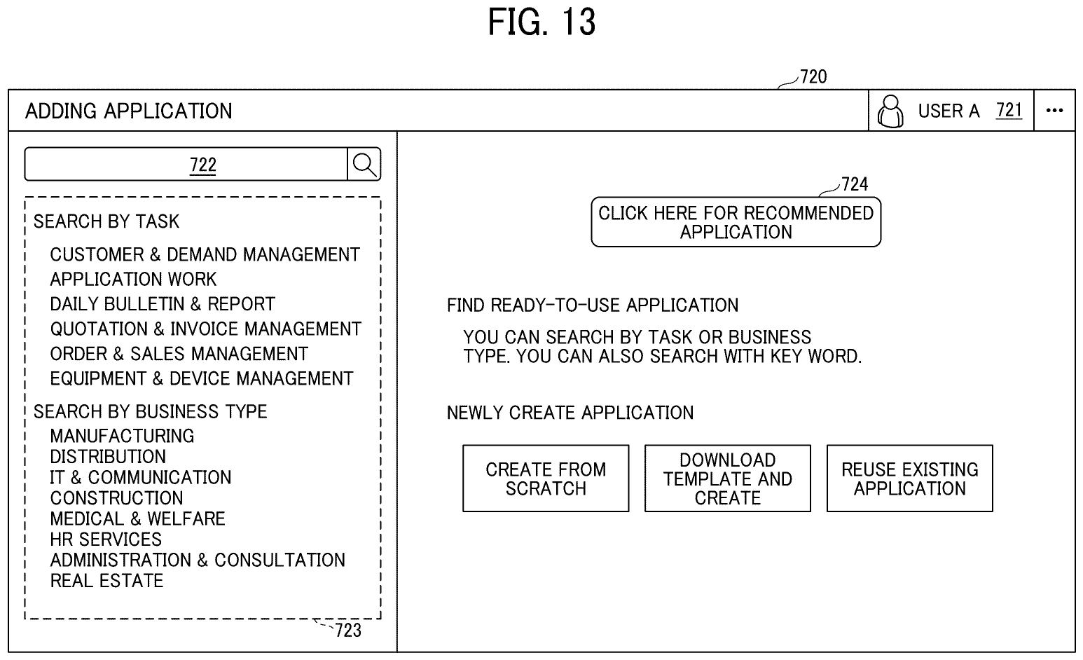

FIG. 13 is a diagram illustrating an application addition screen 720. As illustrated in FIG. 13, the application addition screen 720 includes a user display field 721, a search condition input field 722, a category selection area 723, and a recommendation display button 724.

In the user display field 721, the information on the user U who is successfully authenticated in step S13 is displayed. In the search condition input field 722, a search condition such as a keyword is input. When a search condition is input in the search condition input field 722, a list of applications that match the search condition is displayed on the application addition screen 720. In the category selection area 723, a selection of a category is received. In the category selection area 723, options of categories determined in advance are displayed. When a category is selected in the category selection area 723, a list of applications included in the selected category is displayed on the application addition screen 720.

The recommendation display button 724 is a button used for displaying the recommendation screen. When the user U presses the recommendation display button 724, a request for acquiring the recommendation screen is received.

Returning to FIG. 10, the description continues. In step S16, the communication control unit 220 of the communication terminal 20 transmits the request for acquiring the recommendation screen to the information processing apparatus 10 in response to an operation by the user U. The request for acquiring the recommendation screen includes the tenant ID. For example, the communication control unit 220 may read out the tenant ID stored in the session storage of the browser B and include the read tenant ID in the request for acquiring the recommendation screen.

In step S17, the request reception unit 120 of the information processing apparatus 10 receives, from the communication terminal 20, the request for acquiring the recommendation screen. The request reception unit 120 notifies the attribute acquisition unit 150 of the request for acquiring the recommendation screen. The attribute acquisition unit 150 acquires the tenant ID from the request for acquiring the recommendation screen. The attribute acquisition unit 150 reads out the tenant information from the tenant storage unit 102 based on the acquired tenant ID. The attribute acquisition unit 150 acquires the attribute information on the organization A from the read tenant information. The attribute acquisition unit 150 transmits the acquired attribute information to the extraction unit 160.

In step S18, the extraction unit 160 of the information processing apparatus 10 receives the attribute information from the attribute acquisition unit 150. The extraction unit 160 reads out the application information from the application storage unit 103. The extraction unit 160 may read out only the application information whose status is registered from the application storage unit 103. The extraction unit 160 selects, from among the pieces of read application information, pieces of application information for which the attribute information satisfies the recommended condition. Specifically, the extraction unit 160 extracts pieces of application information whose type of business matches the type of business of the organization A from among the pieces of application information read from the application storage unit 103. The extraction unit 160 transmits the selected application information to the output unit 170. The extraction unit 160 transmits, to the output unit 170, all the application information or only information to be displayed on the recommendation screen, both of which include at least entirety or a part of the names of the applications. In one example, the extraction unit 160 transmits all the application information including the names of the applications to be recommended. In another example, the extraction unit 160 transmits a part of the application information such as only information to be displayed on the recommendation screen, but including at least the names of the applications to be recommended. Further, even when application information other than the names of the applications are transmitted, only the names of the applications to be recommended may be displayed.

In step S19, the output unit 170 of the information processing apparatus 10 receives the application information from the extraction unit 160. The output unit 170 generates screen data for displaying the recommendation screen based on the application information. In the screen data, a list of applications indicated by the application information is embedded. The output unit 170 transmits the generated screen data to the communication terminal 20.

The output unit 170 may transmit, to the communication terminal 20, the screen data in which the list of applications is not embedded. In this case, a script for acquiring the list of applications using asynchronous processing may be embedded in the screen data. Alternatively, the screen data may include link information for referring to the script for acquiring the list of applications using the asynchronous processing. The script may be executed when the recommendation screen is displayed by the communication terminal 20, and may control to display a list of acquired applications on the recommendation screen. The program of the script may be described in a script language such as JAVASCRIPT.

The output unit 170 may generate a list of applications to be embedded in the recommendation screen according to a display rule determined in advance. In the present embodiment, it is assumed that a display rule that ten applications are displayed in order of the most recent registration date and time is defined. The output unit 170 sorts the pieces of application information in descending order of the registration date and time. The output unit 170 acquires the first ten pieces of application information among the pieces of sorted application information. The output unit 170 generates a list of applications in accordance with the order in which the pieces of application information are acquired. The output unit 170 embeds the generated list of applications in the screen data.

In step S20, the communication control unit 220 of the communication terminal 20 receives the screen data of the recommendation screen from the information processing apparatus 10. The display control unit 210 displays the recommendation screen on the display 506 based on the screen data received from the information processing apparatus 10.

### Recommendation Screen

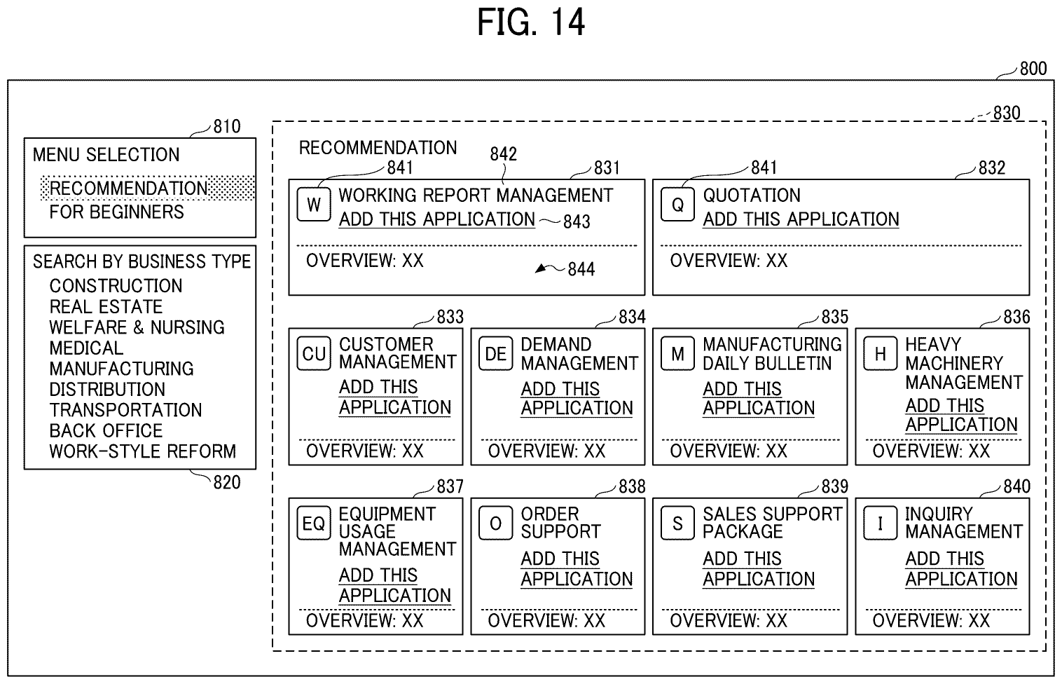

FIG. 14 is a diagram illustrating a recommendation screen 800. As illustrated in FIG. 14, the recommendation screen 800 includes a menu selection area 810, an attribute selection area 820, and a list display area 830.

In the menu selection area 810, a menu used for selecting applications based on criteria determined in advance is displayed. The menu may include, for example, a menu of recommendation and a menu for beginners. The menu of recommendation is a menu for extracting applications recommended to the log-in user such as the user U. The menu for beginners is a menu for extracting applications recommended to users who have just started using the application market. In the initial state, the menu of recommendation is selected in the menu selection area 810. When a menu is selected in the menu selection area 810, a list of the extracted applications is displayed in the list display area 830.

In the attribute selection area 820, a selection of attribute information is received. In the attribute selection area 820, options of attribute information determined in advance are displayed. The options of the attribute information may be options of the type of business of the organization. When attribute information is selected in the attribute selection area 820, a list of applications for which the selected attribute information satisfies the recommended condition is displayed in the list display area 830.

The list display area 830 is a display area where a list of applications is displayed. When the menu of recommendation is selected in the menu selection area 810, a list of applications extracted based on the attribute information on the organization A to which the user U belongs is displayed in the list display area 830.

In the list display area 830, application display areas 831 to 840 are displayed, in which information on individual applications is displayed. The application display areas 831 to 840 are arranged in the list display area 830 according to a display rule. In the case of FIG. 14, the application display areas 831 to 840 are arranged from left to right and from top to bottom on the screen in an order according to the display rule. The application display areas 831 to 840 may be displayed with emphasis on the display order, such that the applications that are earlier in the display order are enhanced. In the case of the display with emphasis, for example, the display mode of the size of the area, the background color, the character color, and the thickness of the characters may be changed to another display mode that allows easiness in visual recognition. The display mode of the application display areas 831 to 840 illustrated in FIG. 14 is given by way of example. The arrangement or the emphasis of the application display areas may be changed as desired.

Each of the application display areas 831 to 840 includes an icon field 841, a name field 842, an additional link 843, and an overview field 844. In the icon field 841, a predetermined icon set for the application may be displayed. In the name field 842 and the overview field 844, the name and the overview of the application information may be displayed, respectively, based on the application information obtained from the table of FIG. 6.

The additional link 843 is a link that allows the user U to use an application. When the user U selects the additional link 843 of an application desired to be used, the selected application is provided to the user U. When the application is provided, the user U is allowed to use the application. The user U can activate the application in, for example, the application display area 716 of the portal screen 710.

It is assumed that the selected application is provided with a fee. In the application market, a payment screen may be displayed, and the application is provided to the user U after the payment of the usage fee is completed by the user U.

The information processing apparatus 10 identifies the user U who operates the communication terminal 20 and the organization A to which the user U belongs, and selects one or more applications recommended to the user U based on the attribute information on the attributes of the organization A. By using the attribute information on the organization A, an application to be used by the user U in performing the tasks of the organization A is appropriately extracted. Accordingly, an application suitable for the organization A to which the user U belongs is recommended.

The information processing apparatus 10 may extract one or more applications for which the attribute information on the attributes of the organization A satisfies the recommended condition, based on the application information associated with the recommended condition relating to the attributes of the organization for which each of the one or more applications is recommended to be used. According to the present embodiment, an application that satisfies a recommended condition determined in advance by the attribute information on the organization A is recommended.

The attribute information may include information indicating the type of business of the organization A. The attribute information may include information indicating the scale of the organization A. According to the present embodiment, an application in accordance with the type of business or scale of the organization A to which the user U belongs is recommended.

The information processing apparatus 10 may identify the organization A based on the authentication information input by the user U. Alternatively, the information processing apparatus 10 may identify the organization A based on the connection destination information of the communication terminal 20. According to the present embodiment, the organization A to which the user U belongs is identified by various methods.

The information processing apparatus 10 may cause the communication terminal 20 to display information on the application based on a rule determined in advance. The rule may indicate the number and order of applications to be displayed by the communication terminal 20. The rule may include a rule relating to the registration date and time of the application. According to the present embodiment, an application is recommended in a display mode that allows the user U to easily understand.

In the embodiment described above referring to FIGS. 3 to 14, the configuration in which an application is extracted based on the attribute information on the organization A to which the user U belongs is described. Alternatively, an application may be selected based on the attribute information on the user U in addition to the attribute information on the organization A.

The functional configuration and the operation of the information processing apparatus 10 is described below, focusing on the differences from the information processing apparatus of FIG. 3.

### User Information

The user information includes identification information (user ID) for identifying the user U, authentication information for authenticating the user U, and attribute information indicating the attributes of the user U. The attribute information on the user U may include the attribute information on the tasks of the organization A.

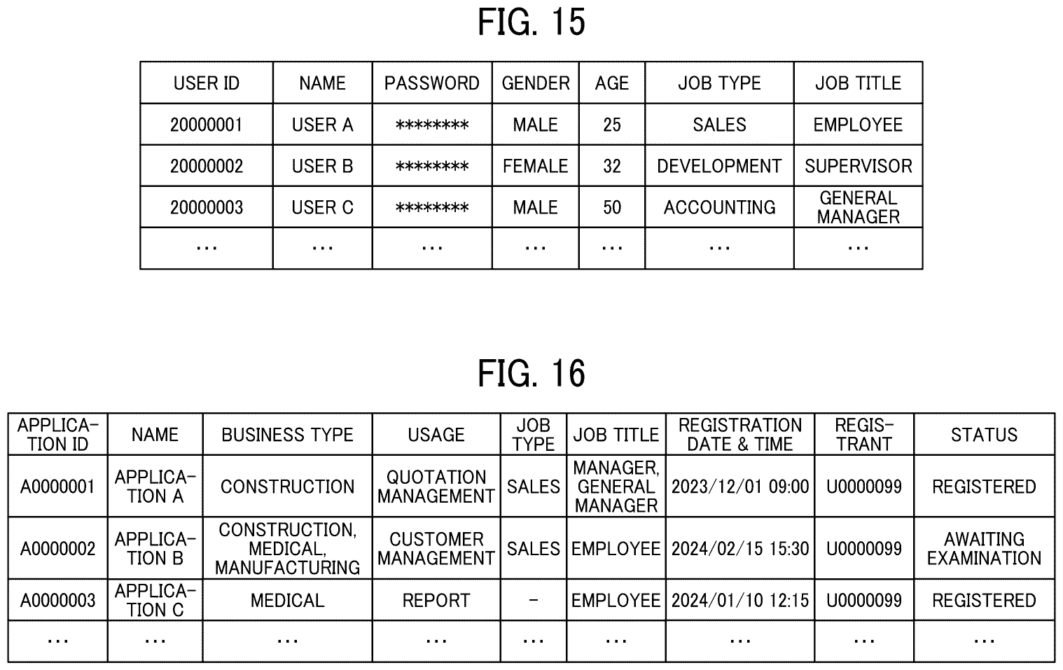

FIG. 15 is a table illustrating another data structure of the user information. As illustrated in FIG. 15, the user information includes, for example, a user ID, a name, a password, a gender, an age, a job type, and a job title as data items. The name, password, gender, age, job type, and job title are examples of the attribute information on the user U. The job type and job title are examples of the attribute information on the tasks of the organization A.

### Application Information

The application information includes identification information (application ID) for identifying an application, classification information indicating a classification of the application, and a recommended condition indicating conditions under which the application is recommended. The recommended condition may include a condition relating to the attribute information included in the user information in addition to a condition relating to the attribute information included in the tenant information.

FIG. 16 is a table illustrating another data structure of the application information. As illustrated in FIG. 16, the application information includes, for example, an application ID, a name, a type of business, a usage, a job type, a job title, a registration date and time, a registrant, and a status as data items. The job type and job title are examples of the recommended condition, and are conditions relating to the job type and job title of the user information, respectively.

The attribute acquisition unit 150 further acquires the attribute information (an example of second attribute information) on the user U identified by the user identification unit 130 in addition to the attribute information on the organization A identified by the organization identification unit 140. The attribute acquisition unit 150 may read out the attribute information on the user U identified by the user identification unit 130 from the user storage unit 101.

The extraction unit 160 extracts an application recommended to the user U based on both the attribute information on the organization A and the attribute information on the user U acquired by the attribute acquisition unit 150. Specifically, the extraction unit 160 extracts, from among the pieces of application information read from the application storage unit 103, pieces of application information for which the attribute information on the organization A satisfies the recommended condition. The extraction unit 160 further extracts, from among the pieces of application information extracted based on the attribute information on the organization A, pieces of application information for which the attribute information on the user U satisfies the recommended condition.

The information processing apparatus 10 acquires the attribute information on the user U, and extracts an application for which both the attribute information on the organization A and the attribute information on the user U satisfy the recommended condition. The attribute information on the user U may include the attribute information on the tasks of the organization A. By using both the attribute information on the organization A and the attribute information on the user U, an application to be used by the user U for the tasks of the organization A is appropriately extracted. In one aspect, according to the present embodiment, an application suitable for the organization A to which the user U belongs is recommended.

In the above embodiments, a case in which a user interface of the information processing system 1000 is provided by the information processing apparatus 10 is described. However, the user interface of the information processing system 1000 may be provided by another information processing apparatus different from the information processing apparatus 10. For example, the user interface of the information processing system 1000 may be provided by the other information processing apparatus, and the information processing apparatus 10 may provide a list of applications recommended to the user U in response to a request from the other information processing apparatus. As another example, the other information processing apparatus may provide some of the screens including, for example, the login screen, the portal screen, and the application addition screen, and the information processing apparatus 10 may provide other screens including the recommendation screen.

The display control unit 210 of the communication terminal 20 may display the various screens using the asynchronous communication. The asynchronous communication may be performed using, for example, a technique such as Ajax (Asynchronous JAVASCRIPT and extensible markup language (XML)). The display control unit 210 may be implemented by any application that enables the asynchronous communication and has a function to display web content data. Examples of the function of displaying the web content data include a web browser function and the WebView function. The display control unit 210 may be implemented by, for example, a web browser application, an application having a web browser function, or an application that displays web contents using the WebView function. The display control unit 210 is an example of an application installed in a communication terminal.

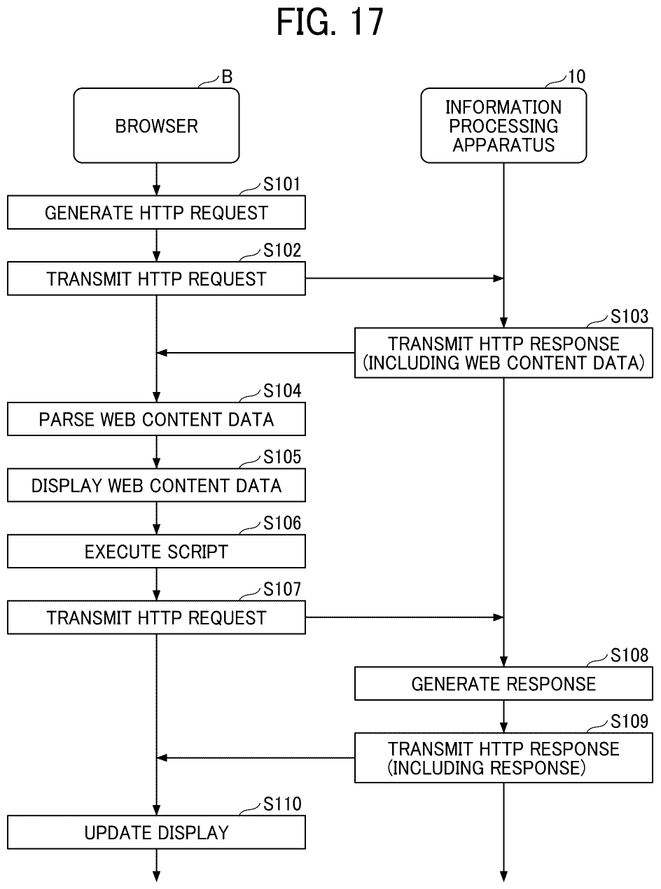

A screen display process to display the recommendation screen using the asynchronous communication is specifically described below with reference to FIG. 17. FIG. 17 is a sequence diagram illustrating the screen display process. In FIG. 17, a case in which the display control unit 210 is implemented by a web browser application is described.

In step S101, the browser B generates a hypertext transfer protocol (HTTP) request specifying a URL of a web page in response to an operation by the user U. The operation by the user U may be an operation of pressing the recommendation display button 724 on the application addition screen 720 illustrated in FIG. 13.

In step S102, the browser B transmits the HTTP request generated in step S101 to the information processing apparatus 10. The process of step S102 corresponds to the process of step S16 illustrated in FIG. 10.

In step S103, in response to receiving the HTTP request from the browser B, the information processing apparatus 10 transmits an HTTP response that includes web content data to the browser B. At this time, the information processing apparatus 10 generates web content data according to the URL specified in the HTTP request.

The web content data is, for example, data described in the HTML. The web content data may include JAVASCRIPT (an example of a first JAVASCRIPT) in which a process for acquiring application information is described. Alternatively, the web content data may include link information for referring to JAVASCRIPT (an example of a second JAVASCRIPT) in which a process for acquiring the application information is described.

An example in which the first JAVASCRIPT is described in the web content data and another example in which the link information for referring to the second JAVASCRIPT is described in the web content data are described below. In the following description, “GetRecommendAppData( )” is an example of the first JAVASCRIPT and the second JAVASCRIPT in each of which the process of acquiring the application data is described.

### Example of Description of First JAVASCRIPT

In the HTML, “<script>function GetRecommendAppData( ){ . . . }</script>” is directly described. This JAVASCRIPT is read, for example, when the HTML is parsed by the browser B.

### Example of Description of Link Information for Referring to Second JAVASCRIPT

In the HTML, “<script type=“text/javascript”src=“http://www.xxx.jp/scripts/GetRecommendAppData.js”></script>“ is described as a link for referring to “http://www.xxx.jp/scripts/GetRecommendAppData.js.” In the file (GetRecommendAppData.js) of the destination of the link, “<script>function GetRecommendAppData( ){ . . . }</script>” is described as the description of the first JAVASCRIPT. When parsing the HTML, the browser B accesses the destination of the link and reads, for example, “GetRecommendAppData( )” included in the file (GetRecommendAppData.js).

In step S104, the browser B receives the HTTP response from the information processing apparatus 10. The browser B interprets (parses) the web content data included in the HTTP response. At this time, in the case where the web content data includes link information for referring to JAVASCRIPT, the browser B accesses the destination of the link indicated in the link information and reads the JAVASCRIPT.

In step S105, the browser B loads the web content data parsed in step S104. As a result, the recommendation screen is displayed in the display area of the browser B. At this time, since the application information is not included in the web content data, only the frame of the recommendation screen is displayed.

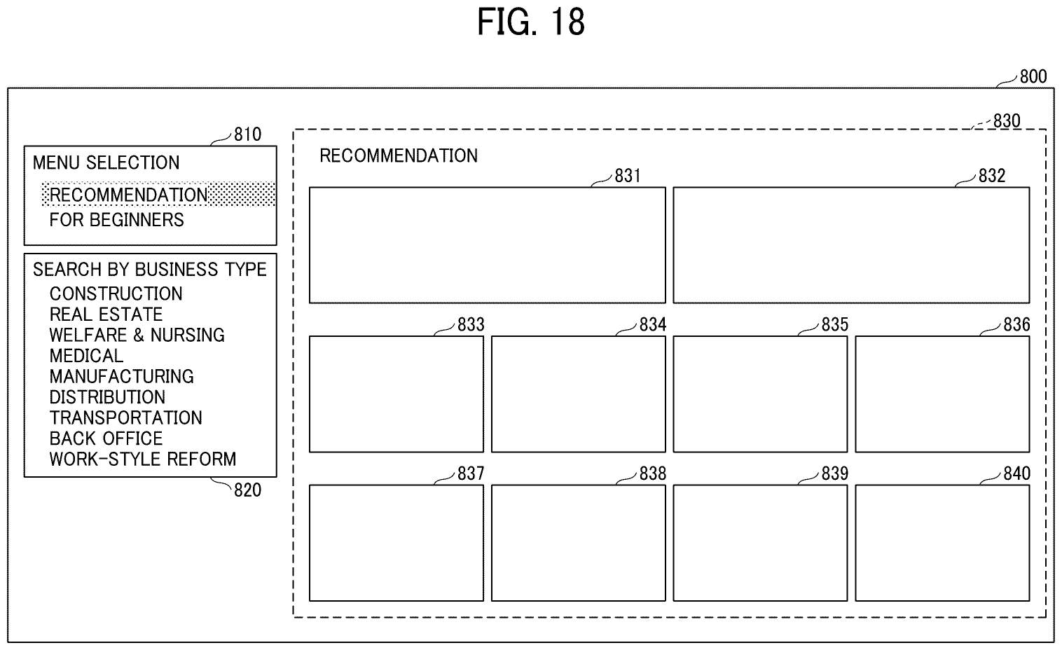

FIG. 18 is a diagram illustrating the recommendation screen 800. In FIG. 18, an example of a recommendation screen on which the web content data not including application information is displayed is illustrated. As illustrated in FIG. 18, in the case where the application information is not included in the web content data, only the frames of the application display areas 831 to 840 are displayed in the list display area 830 on the recommendation screen 800. In the example illustrated in FIG. 18, the icon field 841, the name field 842, the additional link 843, and the overview field 844 are not displayed in the application display areas 831 to 840. However, the icon field 841, the name field 842, the additional link 843, and the overview field 844 may be displayed as blank fields (or with respective initial values).

In step S106, the browser B executes the JAVASCRIPT included in the web content data loaded in step S105. The JAVASCRIPT generates an HTTP request that includes a GET method for acquiring application data to be displayed on the recommendation screen from the information processing apparatus 10.

In step S107, the browser B transmits the HTTP request generated in step S106 to the information processing apparatus 10.

In step S108, the information processing apparatus 10 receives the HTTP request from the browser B. In response to the HTTP request, the information processing apparatus 10 generates a response that includes the application information. For example, the response may be described in the format of JavaScript Object Notation (JSON).

The information processing apparatus 10 executes the processes of steps S17 and S18 illustrated in FIG. 10 in order to acquire the application information to be included in the response. In one example, the information processing apparatus 10 may execute the process of step S17 to acquire the attribute information before executing the process of step S108. Alternatively, the information processing apparatus 10 may execute the processes of steps S17 and S18 to acquire the application information before executing the process of step S108. For example, the information processing apparatus 10 may acquire the application information before transmitting the web content data in step S103.

Further, the information processing apparatus 10 may embed information for acquiring the application information in the web content data when generating the web content data in step S103. For example, the information processing apparatus 10 may generate web content data that includes a tenant ID. In this case, the following processes may be described in the JAVASCRIPT as the processes for acquiring the application information. In particular, the processes include reading the tenant ID included in the web content data, and causing the read tenant ID to be included in a GET method that acquires the application information to be displayed on the recommendation screen from the information processing apparatus 10. The information processing apparatus 10 may use the tenant ID included in the HTTP request when executing the process of step S17 illustrated in FIG. 10 in order to acquire the application information. Accordingly, the information processing apparatus 10 does not need to keep storing the tenant ID acquired in step S14 illustrated in FIG. 10.

In the case where the information processing apparatus 10 executes the process of step S17 before executing the process of step S108 to acquire the attribute information, the information processing apparatus 10 may generate web content data that includes the attribute information. In this case, the following processes may be described in the JAVASCRIPT as the processes for acquiring the application information. In particular, the processes include reading the attribute information included in the web content data, and causing the read attribute information to be included in a GET method that acquires the application information to be displayed on the recommendation screen from the information processing apparatus 10. The information processing apparatus 10 may use the attribute information included in the HTTP request when executing the process of step S18 illustrated in FIG. 10 in order to acquire the application information.

In step S109, the information processing apparatus 10 transmits an HTTP response including the response generated in step S108 to the browser B.

In step S110, the browser B receives the HTTP response from the information processing apparatus 10. The browser B displays the application information on the recommendation screen based on the response included in the HTTP response. In the case of the recommendation screen 800 illustrated in FIG. 14, the information of the icon field 841, the name field 842, the additional link 843, and the overview field 844 in the application display areas 831 to 840 displayed in step S105 are updated based on the application information.

In the asynchronous communication, the display of a web page and the acquisition of part of content to be displayed on the web page are performed at different times. The web page previously displayed is updated with the part of the content acquired later. When the screen display is performed using the asynchronous communication, only the part of the content to be updated needs to be acquired for updating the display content of the web page. Thus, the web page is displayed in high speed.

To illustrate the operation of FIG. 17, the recommendation screen 800 illustrated in FIG. 14 is described below as an example. It is assumed that there are 30 applications recommended to the user U. In the case where the asynchronous communication is not used, all 30 pieces of application information must be acquired first, and screen data including the 30 pieces of application information must be generated. Therefore, it takes a long time to display the recommendation screen 800.

In contrary, when the asynchronous communication is used, the time it takes for displaying the recommendation screen 800 can be made shorter. When the recommendation screen 800 is initially displayed, for example, only ten pieces of application information are acquired from the information processing apparatus 10 and displayed in the list display area 830. The remaining 20 pieces of application information may be acquired, for example, when the display content is updated by the recommendation screen 800 being scrolled. When the recommendation screen 800 is displayed, only ten pieces of application information are acquired first, and the screen data including the ten pieces of application information is generated. As a result, the recommendation screen 800 is displayed in higher speed. Accordingly, by using the asynchronous communication, the time it takes for displaying the recommendation screen 800 is made shorter.

Each of the functions of the embodiments described above may be implemented by one or more processing circuits or circuitry. The “processing circuit or circuitry” herein includes a programmed processor to execute each function by software, such as a processor implemented by an electronic circuit, and devices, such as an application-specific integrated circuit (ASIC), a digital signal processor (DSP), a field-programmable gate array (FPGA), and circuit modules known in the art arranged to perform the recited functions.

The group of apparatuses or devices described in one or more embodiments of the present disclosure is merely one example of plural computing environments that implement the one or more embodiments disclosed herein. In some embodiments, the information processing apparatus 10 may include multiple computing devices such as a server cluster.

The multiple computing devices communicate with one another through any type of communication link including, for example, a network or a shared memory, and perform the operations disclosed herein.

Aspects of the present disclosure are, for example, as follows.

According to Aspect 1, an information processing apparatus that communicates with a communication terminal via a network includes a user identification unit that identifies a user who operates the communication terminal, an organization identification unit that identifies an organization to which the user belongs, an attribute acquisition unit that acquires attribute information on an attribute of the identified organization, an extraction unit that extracts one or more applications recommended to the user from among multiple applications available to the user based on the acquired attribute information, and an output unit that transmits, to the communication terminal, control information for causing the communication terminal to display application information relating to the one or more applications. The application information includes at least an application name of each of the one or more applications.

According to Aspect 2, the information processing apparatus of Aspect 1 further includes a storage unit that stores setting information associated with a recommended condition relating to the attribute of the organization for which each of the multiple applications is recommended to be used. The extraction unit extracts, from among the multiple applications available to the user, the one or more applications for which the attribute relating to the acquired attribute information on the organization satisfies the recommended condition.

According to Aspect 3, in the information processing apparatus of Aspect 2, the setting information is further associated with the recommended condition relating to another attribute of the user for which each of the multiple applications is recommended to be used, the attribute acquisition unit further acquires another attribute information on the user, and the extraction unit extracts the application for which both the attribute information and the other attribute information satisfy the recommended condition.

According to Aspect 4, in the information processing apparatus of any one of Aspects 1 to 3, the control information is web content data that can be displayed by an application having a browser function installed in the communication terminal.

According to Aspect 5, an information processing apparatus that communicates with, via a network, a communication terminal in which an application having a function to display web content data is installed includes a user identification unit that identifies a user who operates the communication terminal, an organization identification unit that identifies an organization to which the user belongs, an attribute acquisition unit that acquires attribute information on an attribute of the identified organization, an extraction unit that extracts one or more applications recommended to the user from among multiple applications available to the user based on the acquired attribute information, and a first transmission unit that transmits the web content data described in a format of HTML to the communication terminal in response to receiving a first HTTP request transmitted from the communication terminal. The web content data includes a first JAVASCRIPT for acquiring application information including at least an application name of each of the one or more applications from the information processing apparatus or link information for referring to a second JAVASCRIPT for acquiring the application information from the information processing apparatus. The information processing apparatus further includes a second transmission unit that transmits the application information to the communication terminal in response to receiving a second HTTP request transmitted from the communication terminal when the application installed in the communication terminal executes the first JAVASCRIPT included in the web content data or the second JAVASCRIPT identified by the link information included in the web content data. The web content data is web content data for causing the communication terminal to display the application name on a screen when the application installed in the communication terminal executes the first JAVASCRIPT or the second JAVASCRIPT.

According to Aspect 6, in the information processing apparatus of Aspect 5, the extraction unit extracts the one or more applications recommended to the user based on the acquired attribute information in response to receiving the second HTTP request.

According to Aspect 7, the information processing apparatus of Aspect 5 or 6 further includes a storage unit that stores setting information associated with a recommended condition relating to the attribute of the organization for which each of the multiple applications is recommended to be used. The extraction unit extracts, from among the multiple applications available to the user, the one or more applications for which the attribute relating to the acquired attribute information on the organization satisfies the recommended condition.

According to Aspect 8, in the information processing apparatus of Aspect 7, the setting information is further associated with the recommended condition relating to another attribute of the user for which each of the multiple applications is recommended to be used, the attribute acquisition unit further acquires another attribute information on the user, and the extraction unit extracts the one or more applications for which both the attribute information and the other attribute information satisfy the recommended condition.

According to Aspect 9, in the information processing apparatus of any one of Aspects 1 to 8, the attribute information includes information indicating a type of business of the organization.

According to Aspect 10, in the information processing apparatus of any one of Aspects 1 to 8, the attribute information includes information indicating the scale of the organization.

According to Aspect 11, in the information processing apparatus of Aspect 3, the other attribute information includes information on the tasks of the organization.

According to Aspect 12, in the information processing apparatus of any one of Aspects 1 to 11, the organization identification unit identifies the organization based on authentication information input by the user.

According to Aspect 13, in the information processing apparatus of any one of Aspects 1 to 11, the organization identification unit identifies the organization based on connection destination information of the communication terminal.

According to Aspect 14, in the information processing apparatus of any one of Aspects 1 to 4, the control information causes the communication terminal to display the application information based on a rule determined in advance.

According to Aspect 15, in the information processing apparatus of Aspect 14, the rule indicates the number and order of the one or more applications to be displayed by the communication terminal.

According to Aspect 16, in the information processing apparatus of Aspect 14, the rule includes a rule relating to a registration date and time of each of the one or more applications.

According to Aspect 17, a system includes a communication terminal and an information processing apparatus that communicate with each other via a network. The information processing apparatus includes a user identification unit that identifies a user who operates the communication terminal, an organization identification unit that identifies an organization to which the user belongs, an attribute acquisition unit that acquires attribute information on an attribute of the identified organization, an extraction unit that extracts one or more applications recommended to the user from among multiple applications available to the user based on the acquired attribute information, and an output unit that transmits, to the communication terminal, control information for causing the communication terminal to display application information relating to the one or more applications. The application information includes at least an application name of each of the one or more applications. The communication terminal includes a display control unit that displays the application name on a display device based on the control information received from the information processing apparatus.

According to Aspect 18, an information processing method performed by a computer that communicates with a communication terminal via a network includes identifying a user who operates the communication terminal, identifying an organization to which the user belongs, acquiring attribute information on an attribute of the identified organization, extracting one or more applications recommended to the user from among multiple applications available to the user based on the acquired attribute information, and transmitting, to the communication terminal, control information for causing the communication terminal to display application information relating to the one or more applications. The application information includes at least an application name of each of the one or more applications.

According to Aspect 19, a non-transitory recording medium stores a plurality of program codes which, when executed by a computer that communicates with a communication terminal via a network, causes the computer to perform a method including identifying a user who operates the communication terminal, identifying an organization to which the user belongs, acquiring attribute information on an attribute of the identified organization, extracting one or more applications recommended to the user from among multiple applications available to the user based on the acquired attribute information, and transmitting, to the communication terminal, control information for causing the communication terminal to display application information relating to the one or more applications. The application information includes at least an application of each of the one or more applications.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

In another aspect, a non-transitory recording medium stores a plurality of program codes which, when executed by one or more processors on an information processing apparatus, causes the one or more processors to perform a method including identifying a user who operates a communication terminal communicable with the information processing apparatus via a network, the communication terminal being installed with a terminal application, identifying an organization to which the user belongs, acquiring attribute information on an attribute of the organization, selecting one or more applications to be recommended to the user from among a plurality of applications available to the user based on the attribute information, transmitting web content data described in hypertext markup language (HTML) to the communication terminal in response to receiving a first hypertext transfer protocol (HTTP) request transmitted from the communication terminal, the web content data including a first JAVASCRIPT or link information for referring to a second JAVASCRIPT, the first JAVASCRIPT being for acquiring application information on the one or more applications to be recommended from the information processing apparatus, the second JAVASCRIPT being for acquiring the application information from the information processing apparatus, and transmitting at least an application name of each of the one or more applications to be recommended to the communication terminal in response to receiving a second HTTP request, the second HTTP request being transmitted from the communication terminal in response to execution of the first JAVASCRIPT or the second JAVASCRIPT by the terminal application, the web content data causing the communication terminal to display the application name a screen based on the application name transmitted from the information processing apparatus.

1. An information processing apparatus, comprising circuitry configured to:
identify a user who operates a communication terminal communicable with the information processing apparatus via a network, the communication terminal being installed with a terminal application;
identify an organization to which the user belongs;
acquire attribute information on an attribute of the organization;
select one or more applications to be recommended to the user from among a plurality of applications available to the user based on the attribute information;
transmit web content data described in hypertext markup language (HTML) to the communication terminal in response to receiving a first hypertext transfer protocol (HTTP) request transmitted from the communication terminal, the web content data including a first JAVASCRIPT or link information for referring to a second JAVASCRIPT,
the first JAVASCRIPT being for acquiring application information on the one or more applications to be recommended from the information processing apparatus,
the second JAVASCRIPT being for acquiring the application information from the information processing apparatus; and
transmit at least an application name of each of the one or more applications to be recommended to the communication terminal in response to receiving a second HTTP request, the second HTTP request being transmitted from the communication terminal in response to execution of the first JAVASCRIPT or the second JAVASCRIPT by the terminal application,
the web content data causing the communication terminal to display the application name on a screen based on the application name transmitted from the information processing apparatus.

2. The information processing apparatus according to claim 1, wherein the circuitry is configured to select the one or more applications to be recommended to the user based on the attribute information in response to receiving the second HTTP request.

3. The information processing apparatus according to claim 1, further comprising a memory that stores the application information associating each application with a recommended condition indicating a condition under which use of each application is recommended, the recommended condition relating to the attribute of the organization of the user, wherein,
the circuitry is configured to select, from among the plurality of applications available to the user, the one or more applications associated with the attribute satisfying the recommended condition, the attribute being indicated by the attribute information on the organization.

4. The information processing apparatus according to claim 3, wherein,
the recommended condition of the application information further relates to an attribute of the user, and
the circuitry is configured to:
acquire another attribute information on the attribute of the user; and
select the one or more applications further associated with the attribute of the user satisfying the recommended condition.

5. The information processing apparatus according to claim 1, wherein the attribute information includes information indicating a type of business of the organization.

6. The information processing apparatus according to claim 1, wherein the attribute information includes information indicating a scale of the organization.

7. The information processing apparatus according to claim 3, wherein the attribute information includes information on a task of the organization.

8. The information processing apparatus according to claim 1, wherein the circuitry is configured to identify the organization based on authentication information input by the user.

9. The information processing apparatus according to claim 1, wherein the circuitry is configured to identify the organization based on connection destination information of the communication terminal.

10. An information processing method performed by an information processing apparatus, the method comprising:
identifying a user who operates a communication terminal communicable with the information processing apparatus via a network, the communication terminal being installed with a terminal application;
identifying an organization to which the user belongs;
acquiring attribute information on an attribute of the organization;
selecting one or more applications to be recommended to the user from among a plurality of applications available to the user based on the attribute information;
transmitting web content data described in hypertext markup language (HTML) to the communication terminal in response to receiving a first hypertext transfer protocol (HTTP) request transmitted from the communication terminal, the web content data including a first JAVASCRIPT or link information for referring to a second JAVASCRIPT,
the first JAVASCRIPT being for acquiring application information on the one or more applications to be recommended from the information processing apparatus,
the second JAVASCRIPT being for acquiring the application information from the information processing apparatus; and
transmitting at least an application name of each of the one or more applications to be recommended to the communication terminal in response to receiving a second HTTP request, the second HTTP request being transmitted from the communication terminal in response to execution of the first JAVASCRIPT or the second JAVASCRIPT by the terminal application,
the web content data causing the communication terminal to display the application name on a screen based on the application name transmitted from the information processing apparatus.

11. A system comprising:
a communication terminal installed with a terminal application for causing the communication terminal to display web content data; and
an information processing apparatus to communicate with the communication terminal via a network,
the information processing apparatus including first circuitry configured to:
identify a user who operates the communication terminal;
identify an organization to which the user belongs;
acquire attribute information on an attribute of the organization;
select one or more applications to be recommended to the user from among a plurality of applications available to the user based on the attribute information; and
transmit the web content data described in HTML to the communication terminal in response to receiving a first HTTP request transmitted from the communication terminal, the web content data including a first JAVASCRIPT or link information for referring to a second JAVASCRIPT,
the first JAVASCRIPT being for acquiring application information on the one or more applications to be recommended from the information processing apparatus,
the second JAVASCRIPT being for acquiring the application information from the information processing apparatus; and
transmit at least an application name of each of the one or more applications to be recommended to the communication terminal in response to receiving a second HTTP request,
the communication terminal including second circuitry configured to:
transmit the first HTTP request;
transmit the second HTTP request in response to execution of the first JAVASCRIPT or the second JAVASCRIPT by the terminal application; and
display the application name on a screen based on the application name transmitted from the information processing apparatus.
